(19) United States
(12) Patent Application Publication
(10) Pub. No.: US 2004/0083623 A1
(43) Pub. Date: May 6, 2004

(54) Shoe vamp having a pattern and a forming mold for forming the shoe vamp

(76) Inventor: Chun-Ming Lu, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/287,517

(22) Filed: Nov. 5, 2002

(51) Int. Cl. A43B 23/00; B28B 7/28

(52) U.S. Cl. 36/45; 249/184

(57) ABSTRACT

A shoe vamp having a pattern includes a pattern layer, and a thermoplastic layer. The pattern layer is permeable and expandable, and includes an outer side printed with a pattern. The thermoplastic layer includes an outer layer and an inner layer. The outer layer infiltrates into the outer side of the pattern layer to wholly and completely cover and encompass the outer side of the pattern layer. The inner layer covers the inner side of the pattern layer and combines with the outer layer. Thus, the surface of the shoe vamp is formed with a pattern which is changed and varied according to the pattern variations of the pattern layer, thereby enhancing the versatility of the shoe vamp, and thereby enhancing the aesthetic quality of the shoe vamp.

### BACKGROUND OF THE INVENTION

1. Field of the Invention

The present invention relates to a shoe vamp having a pattern and a forming mold for forming the shoe vamp, and more particularly to a shoe vamp having a pattern and a forming mold for forming the shoe vamp, wherein the surface of the shoe vamp is formed with a pattern which may be changed and varied according to the pattern variations of the pattern layer, thereby enhancing the versatility of the shoe vamp, and thereby enhancing the aesthetic quality of the shoe vamp.

2. Description of the Related Art

A conventional waterproof boot in accordance with the prior art shown in FIG. 8 comprises a shoe body 4A, and a sole 5A. The shoe body 4A includes a waterproof vamp 41 A and an uppers 42A mounted on the top of the waterproof vamp 41A. The sole 5A is secured on the bottom of the waterproof vamp 41A. However, the waterproof vamp 41A of the shoe body 4A has a three-dimensional configuration, so that the patterns cannot be printed on the surface of the waterproof vamp 41 A of the shoe body 4A, thereby decreasing the versatility of the waterproof vamp 41A of the shoe body 4A, and thereby decreasing the aesthetic quality of the waterproof vamp 41 A of the shoe body 4A.

### SUMMARY OF THE INVENTION

The present invention has arisen to mitigate and/or obviate the disadvantage of the conventional shoe vamp of a waterproof boot.

The primary objective of the present invention is to provide a shoe vamp having a pattern and a forming mold for forming the shoe vamp, wherein the surface of the shoe vamp is formed with a pattern which may be changed and varied according to the pattern variations of the pattern layer of the shoe vamp, thereby enhancing the versatility of the shoe vamp, and thereby enhancing the aesthetic quality of the shoe vamp.

Another objective of the present invention is to provide a shoe vamp having a pattern and a forming mold for forming the shoe vamp, wherein the pattern layer of the shoe vamp is expandable, so that it may be pressed and rested on the surface of the die cavity of the female die. Thus, the surface of the shoe vamp having a three-dimensional configuration presents a three-dimensional pattern by the pattern layer, thereby enhancing the aesthetic quality of the shoe vamp.

A further objective of the present invention is to provide a shoe vamp having a pattern and a forming mold for forming the shoe vamp, wherein after the thermoplastic layer of the shoe vamp is heated and melted, the outer layer of the thermoplastic layer of the shoe vamp is pressurized to infiltrate into the outer side of the pattern layer of the shoe vamp, so as to wholly and completely cover and encompass the outer side of the pattern layer of the shoe vamp, thereby protecting the pattern on the outer side of the pattern layer of the shoe vamp without incurring wear, detachment and fade.

In accordance with one aspect of the present invention, there is provided a shoe vamp having a pattern, comprising a pattern layer, and a thermoplastic layer, wherein:

the pattern layer of the shoe vamp is permeable and expandable, and includes an outer side and an inner side, the outer side of the pattern layer of the shoe vamp is printed with a pattern;

the thermoplastic layer of the shoe vamp includes an outer layer and an inner layer;

the outer layer of the thermoplastic layer of the shoe vamp infiltrates into the outer side of the pattern layer of the shoe vamp, so as to wholly and completely cover and encompass the outer side of the pattern layer of the shoe vamp; and

the inner layer of the thermoplastic layer of the shoe vamp covers the inner side of the pattern layer of the shoe vamp and combines with the outer layer of the thermoplastic layer of the shoe vamp.

In accordance with another aspect of the present invention, there is provided a forming mold for forming a shoe vamp, comprising a male die, and a female die, wherein:

the male die of the forming mold is formed with a protruding die block;

the female die of the forming mold is pivotally mounted on the male die of the forming mold, and is formed with a die cavity to mate with the die block of the male die of the forming mold, the female die of the forming mold has a periphery formed with a plurality of fixing members.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a shoe vamp having a pattern in accordance with a preferred embodiment of the present invention;

FIG. 2 is a cross-sectional view showing the molding process of the shoe vamp having a pattern in accordance with the preferred embodiment of the present invention;

FIG. 3 is a locally enlarged view of a pattern layer of the shoe vamp having a pattern in accordance with the preferred embodiment of the present invention;

FIG. 4 is a partially cut-away cross-sectional view of the shoe vamp having a pattern in accordance with the preferred embodiment of the present invention;

FIG. 5 is a perspective view of a forming mold for forming the shoe vamp in accordance with the preferred embodiment of the present invention;

FIG. 6 is a side plan cross-sectional view of the forming mold for forming the shoe vamp as shown in FIG. 5;

FIG. 7 is a side plan view of a waterproof boot having the shoe vamp in accordance with the preferred embodiment of the present invention; and

FIG. 8 is side plan view of a conventional waterproof boot in accordance with the prior art.

### DETAILED DESCRIPTION OF THE INVENTION

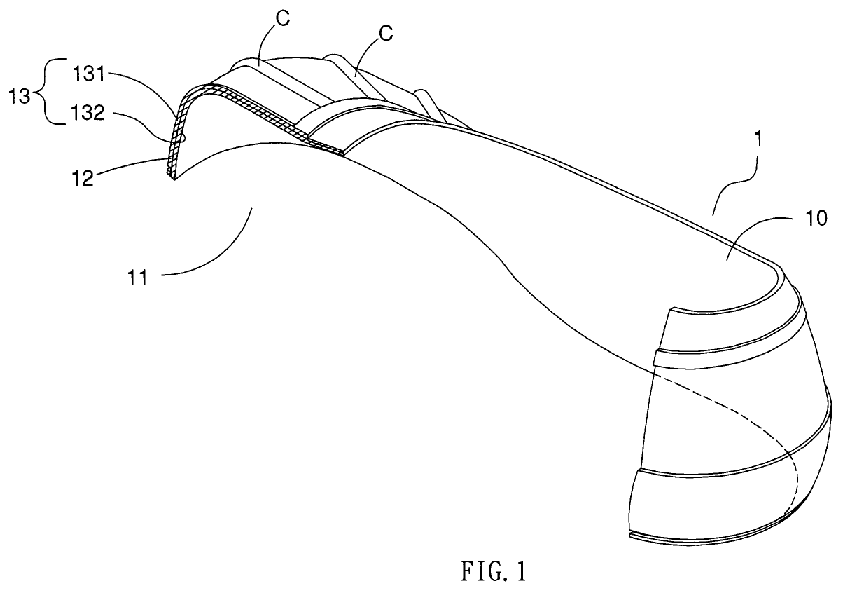

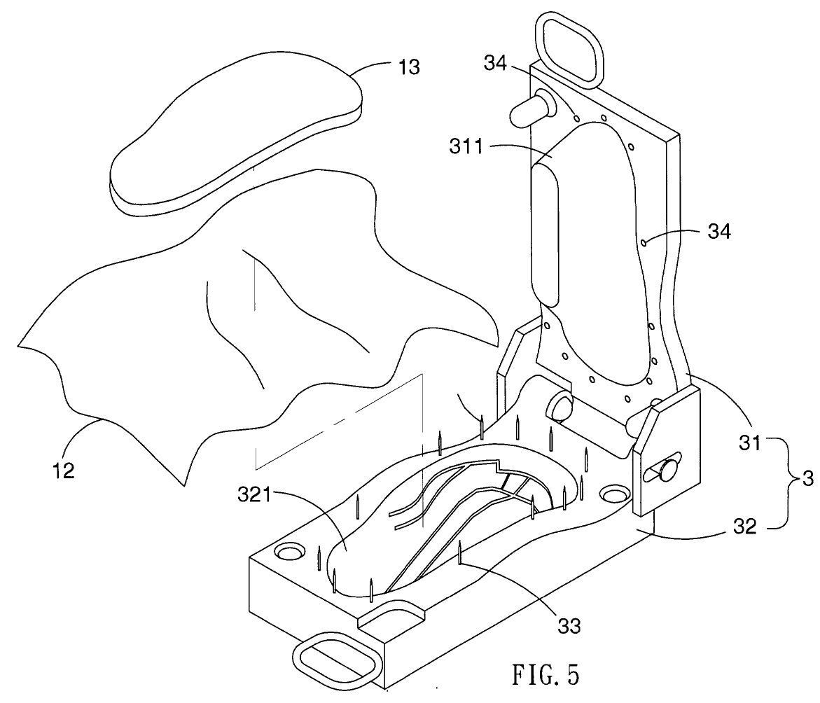

Referring to the drawings and initially to FIGS. 1-4, a shoe vamp 1 having a pattern in accordance with a preferred embodiment of the present invention comprises a pattern layer 12, and a thermoplastic layer 13.

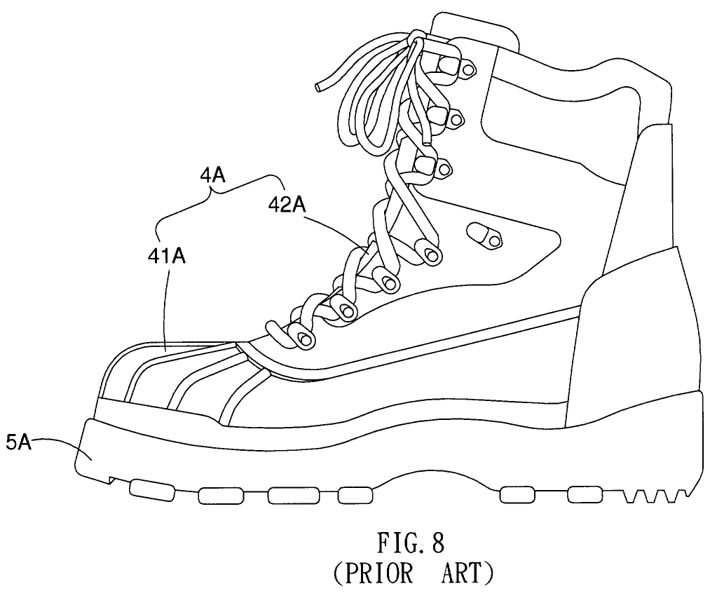

The shoe vamp 1 has a first side formed with a first opening 10 for combining with an uppers 2 (see FIG. 7) and a second side formed with a second opening 11 opposite to the first opening 10 for combining with a sole 3 (see FIG. 7). The shoe vamp 1 has a surface formed with a plurality of protruding ribs “C”.

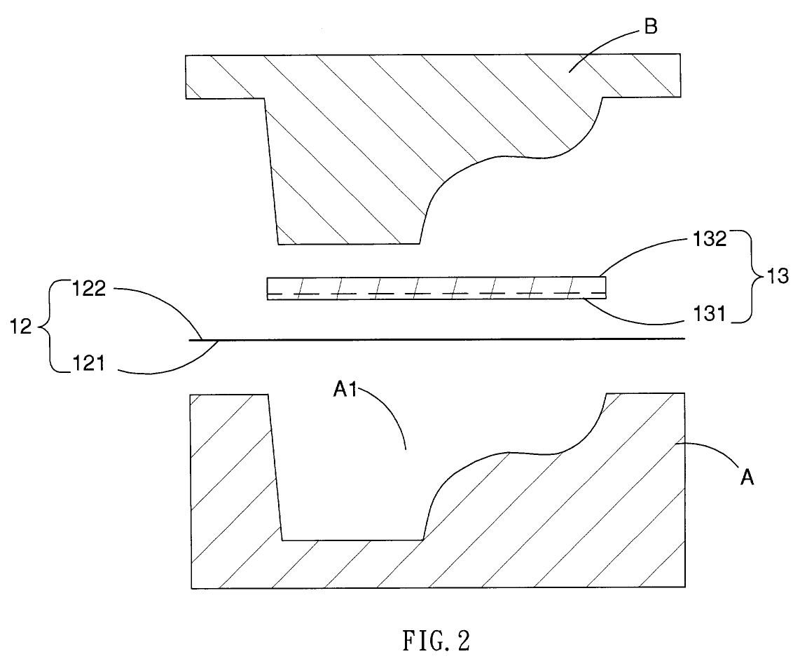

As shown in FIG. 2, the pattern layer 12 and the thermoplastic layer 13 of the shoe vamp 1 are integrally combined with each other by a female die “A” and a male die “B”.

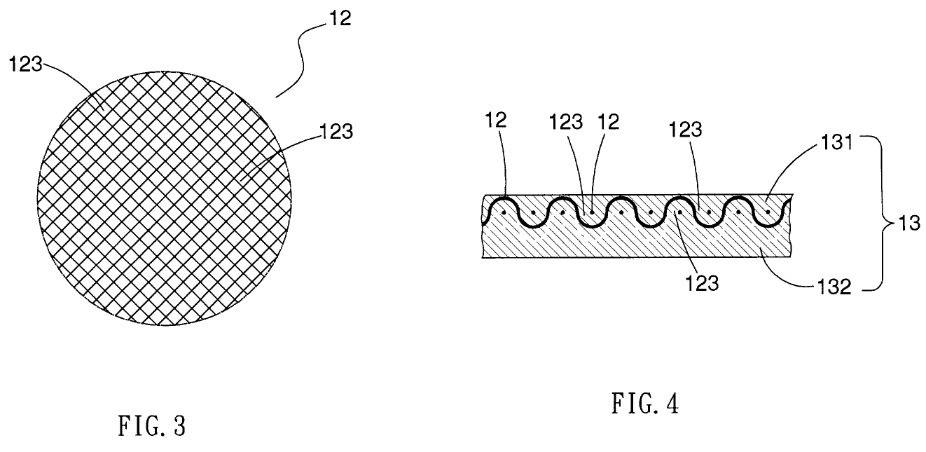

The pattern layer 12 of the shoe vamp 1 is integrally formed in the inside of the thermoplastic layer 13. The pattern layer 12 of the shoe vamp 1 is made a cloth material or the like. The pattern layer 12 of the shoe vamp 1 is permeable and expandable. The pattern layer 12 of the shoe vamp 1 includes an outer side 121 and an inner side 122. The outer side 121 of the pattern layer 12 of the shoe vamp 1 is printed with a pattern (not shown). As shown in FIG. 3, the pattern layer 12 of the shoe vamp 1 is formed with a plurality of permeable smaller meshes 123.

The thermoplastic layer 13 of the shoe vamp 1 is made of a thermoplastic waterproof material, such as rubber, so as to provide a waterproof function. The thermoplastic layer 13 of the shoe vamp 1 includes an outer layer 131 and an inner layer 132.

Referring to FIGS. 2-4 with reference to FIG. 1, the pattern layer 12 and the thermoplastic layer 13 of the shoe vamp 1 are initially placed in the die cavity “A1” of the female die “A”. Then, the male die “B” is inserted into the die cavity “A1” of the female die “A” to close the mold which is pressurized and heated to the temperature of about 140° C., so that the thermoplastic layer 13 of the shoe vamp 1 is melted. Thus, the outer layer 131 of the thermoplastic layer 13 of the shoe vamp 1 is pressurized to pass through the meshes 123 of the pattern layer 12 of the shoe vamp 1 and to cover the outer side 121 of the pattern layer 12 of the shoe vamp 1, and the inner layer 132 of the thermoplastic layer 13 of the shoe vamp 1 covers the inner side 122 of the pattern layer 12 of the shoe vamp 1 and combines with the outer layer 131 of the thermoplastic layer 13 of the shoe vamp 1.

In summary, after the thermoplastic layer 13 of the shoe vamp 1 is heated and melted, the outer layer 131 of the thermoplastic layer 13 of the shoe vamp 1 is pressurized to infiltrate into the outer side 121 of the pattern layer 12 of the shoe vamp 1, so as to wholly and completely cover and encompass the outer side 121 of the pattern layer 12 of the shoe vamp 1, thereby protecting the pattern on the outer side 121 of the pattern layer 12 of the shoe vamp 1, without incurring wear, detachment and fade.

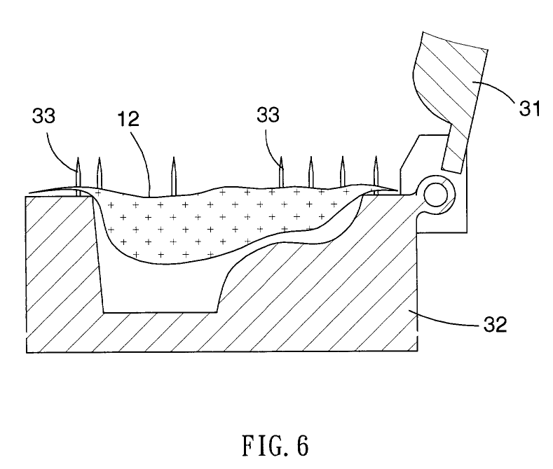

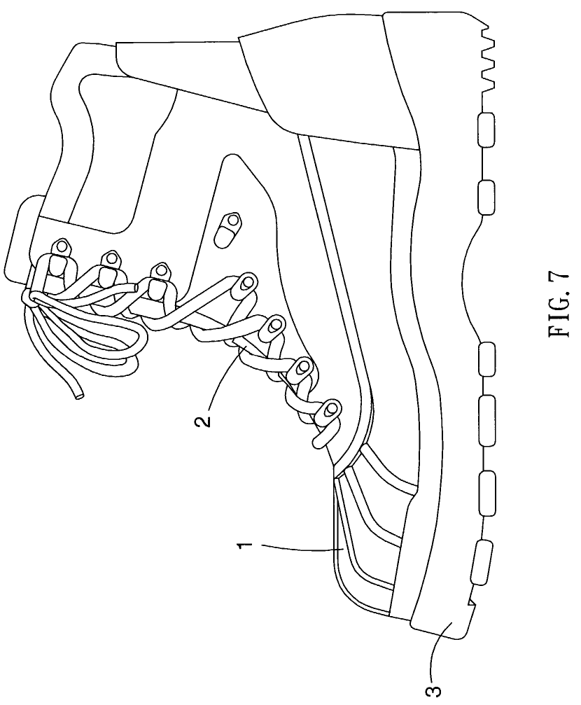

Referring to FIGS. 5 and 6, a forming mold 3 for forming the shoe vamp 1 having a pattern in accordance with the preferred embodiment of the present invention comprises a male die 31 and a female die 32.

The male die 31 of the forming mold 3 is formed with a protruding die block 311, and has a periphery formed with a plurality of insertion recesses 34.

The female die 32 of the forming mold 3 is pivotally mounted on the male die 31 of the forming mold 3. The female die 32 of the forming mold 3 is formed with a die cavity 321 to mate with the die block 311 of the male die 31 of the forming mold 3, and has a periphery formed with a plurality of sharp needle-shaped fixing members 33 to mate with the insertion recesses 34 of the male die 31 of the forming mold 3.

In operation, the pattern layer 12 and the thermoplastic layer 13 of the shoe vamp 1 are initially placed in the die cavity “321” of the female die “32”. Then, the male die “31” is inserted into the die cavity “321” of the female die “32” to close the mold 3 which is pressurized and heated to the temperature of about 140° C., so that the thermoplastic layer 13 of the shoe vamp 1 is melted. Thus, the outer layer 131 of the thermoplastic layer 13 of the shoe vamp 1 is pressurized to pass through the meshes 123 of the pattern layer 12 of the shoe vamp 1 and to cover the outer side 121 of the pattern layer 12 of the shoe vamp 1, and the inner layer 132 of the thermoplastic layer 13 of the shoe vamp 1 covers the inner side 122 of the pattern layer 12 of the shoe vamp 1 and combines with the outer layer 131 of the thermoplastic layer 13 of the shoe vamp 1.

In such a manner, the pattern layer 12 and the thermoplastic layer 13 are heated and pressurized by the forming mold 3 to integrally combine with each other, thereby forming the shoe vamp 1 having a pattern.

During the molding process, the needle-shaped fixing members 33 of the female die 32 of the forming mold 3 penetrates through the pattern layer 12 of the shoe vamp 1 as shown in FIG. 6, so as to fix the pattern layer 12 of the shoe vamp 1, so that the pattern layer 12 of the shoe vamp 1 will not retract into the mold when the male die 31 and the female die 32 of the forming mold 3 are closed.

Accordingly, the surface of the shoe vamp 1 is formed with a pattern which may be changed and varied according to the pattern variations of the pattern layer 12 of the shoe vamp 1, thereby enhancing the versatility of the lo shoe vamp 1, and thereby enhancing the aesthetic quality of the shoe vamp 1.

In addition, the pattern layer 12 of the shoe vamp 1 is expandable, so that it may be pressed and rested on the surface of the die cavity “321” of the female die “32”. Thus, the surface of the shoe vamp 1 having a three-dimensional configuration presents a three-dimensional pattern by the pattern layer 12, thereby enhancing the aesthetic quality of the shoe vamp 1.

Further, after the thermoplastic layer 13 of the shoe vamp 1 is heated and melted, the outer layer 131 of the thermoplastic layer 13 of the shoe vamp 1 is pressurized to infiltrate into the outer side 121 of the pattern layer 12 of the shoe vamp 1, so as to wholly and completely cover and encompass the outer side 121 of the pattern layer 12 of the shoe vamp 1, thereby protecting the pattern on the outer side 121 of the pattern layer 12 of the shoe vamp 1, without incurring wear, detachment and fade.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A shoe vamp having a pattern, comprising a pattern layer, and a thermoplastic layer, wherein:
the pattern layer of the shoe vamp is permeable and expandable, and includes an outer side and an inner side, the outer side of the pattern layer of the shoe vamp is printed with a pattern;
the thermoplastic layer of the shoe vamp includes an outer layer and an inner layer;
the outer layer of the thermoplastic layer of the shoe vamp infiltrates into the outer side of the pattern layer of the shoe vamp, so as to wholly and completely cover and encompass the outer side of the pattern layer of the shoe vamp; and
the inner layer of the thermoplastic layer of the shoe vamp covers the inner side of the pattern layer of the shoe vamp and combines with the outer layer of the thermoplastic layer of the shoe vamp.

2. The shoe vamp having a pattern in accordance with claim 1, wherein the pattern layer and the thermoplastic layer of the shoe vamp are integrally combined with each other.

3. The shoe vamp having a pattern in accordance with claim 1, wherein the pattern layer of the shoe vamp is integrally formed in the inside of the thermoplastic layer.

4. The shoe vamp having a pattern in accordance with claim 1, wherein the pattern layer of the shoe vamp is made a cloth material.

5. The shoe vamp having a pattern in accordance with claim 1, wherein the pattern layer of the shoe vamp is formed with a plurality of permeable smaller meshes.

6. The shoe vamp having a pattern in accordance with claim 1, wherein the thermoplastic layer of the shoe vamp is made of a thermoplastic waterproof material, so as to provide a waterproof function.

7. The shoe vamp having a pattern in accordance with claim 1, wherein the shoe vamp has a first side formed with a first opening for combining with an uppers and a second side formed with a second opening opposite to the first opening for combining with a sole.

8. A forming mold for forming a shoe vamp, comprising a male die, and a female die, wherein:
the male die of the forming mold is formed with a protruding die block;
the female die of the forming mold is pivotally mounted on the male die of the forming mold, and is formed with a die cavity to mate with the die block of the male die of the forming mold, the female die of the forming mold has a periphery formed with a plurality of fixing members.

9. The forming mold for forming a shoe vamp in accordance with claim 8, wherein the male die of the forming mold has a periphery formed with a plurality of insertion recesses for insertion of the fixing members of the female die of the forming mold.

10. The forming mold for forming a shoe vamp in accordance with claim 8, wherein the fixing members of the female die of the forming mold is needle-shaped.
